(19) United States
(12) Patent Application Publication
(10) Pub. No.: US 2019/0055677 A1
(43) Pub. Date: Feb. 21, 2019

(54) SELECTIVE INFILTRATION OF NANOFIBER YARNS

(71) Applicant: Lintec of America, Inc., Richardson, TX (US)

(72) Inventor: Marcio D. Lima, Richardson, TX (US)

(73) Assignee: Lintec of America, Inc., Richardson, TX (US)

(21) Appl. No.: 16/051,586

(22) Filed: Aug. 1, 2018

Related U.S. Application Data
(60) Provisional application No. 62/546,613, filed on Aug. 17, 2017.

(51) Int. Cl. D02G 3/44; D02G 3/36; H01B 1/18

(52) U.S. Cl. CPC D02G 3/441; B82Y 30/00; H01B 1/18; D02G 3/36

(57) ABSTRACT

Techniques are described for infiltrating a nanofiber yarn with an infiltration material and removing a surface layer of the infiltration material on at least a portion of the infiltrated nanofiber yarn. This enables an infiltration method by which the infiltration material is selectively disposed within an interior of a nanofiber yarn and not disposed on an exterior surface of at least a portion of a nanofiber yarn. Electrical connection can be established by mechanically connecting an electrode (e.g., a conductive clamp or fitting) directly to the exposed surface of the nanofiber yarn.

### RELATED APPLICATIONS

This application claims priority under 35 USC § 119(e) to U.S. Provisional Patent Application No. 62/546,613 entitled “Selective Infiltration of Nanofiber Yarns,” filed on Aug. 17, 2017, which is incorporated by reference herein in its entirety.

### TECHNICAL FIELD

The present disclosure relates generally to nanofiber processing. Specifically, the present disclosure relates to selective infiltration of nanofiber yarns.

### BACKGROUND

Nanofiber forests, composed of both single wall and multiwalled nanotubes, can be drawn into nanofiber sheets. In its pre-drawn state the nanofiber forest is in a configuration in which a single layer of nanofibers (or stacks of layers of nanofibers) are parallel to one another and perpendicular to a surface of a growth substrate. When drawn into a nanofiber sheet, the orientation of the nanofibers changes to having a component that is parallel to the surface of the growth substrate. The configuration of the nanofiber sheet is also different relative to the as-grown nanofiber forest. Specifically, the nanotubes in the drawn nanofiber sheet connect to one another in an end-to-end configuration to form a continuous sheet in which a longitudinal axis of the nanofibers is parallel to a plane of the sheet (i.e., parallel to both of the first and second major surfaces of the nanofiber sheet). The nanofiber sheet can be treated in any of a variety of ways, including spinning the nanofiber sheet into a nanofiber yarn.

### SUMMARY

Example 1 of the present disclosure is a collection of nanofibers including: a surface coated section including: a first portion of a plurality of nanofibers defining a first plurality of inter-fiber interstitial spaces in a first interior and having a first external surface; an infiltration material disposed within at least some of the first plurality of inter-fiber interstitial spaces and disposed on the first external surface of the surface coated section; and an exposed surface section continuous with the surface coated section, the exposed surface section comprising including a second portion of the plurality of nanofibers defining a second plurality of inter-fiber interstitial spaces in a second interior and defining a second external surface; and an infiltration material disposed within at least some of the second plurality of inter-fiber interstitial spaces, where the second external surface is exposed.

Example 2 includes the subject matter of Example 1, further comprising a native section comprising a third portion of the plurality of nanofibers defining a third plurality of inter-fiber interstitial spaces in a third interior and defining a third external surface, wherein the third portion of the plurality of inter-fiber interstitial spaces and the third external surface are free of the infiltration material.

Example 3 includes the subject matter of either of Examples 1 or 2, further comprising a conductor in electrical contact with the exposed surface section.

Example 4 includes the subject matter of Example 3, wherein an electrical resistance between the conductor and the collection of continuous nanofibers is less than 3000 Ohm/cm.

Example 5 includes the subject matter of any of Examples 1-4, further comprising an electrical resistance of less than 3000 Ohm/cm at the external surface that is substantially free of the infiltration material and an electrical resistance of greater than 3000 Ohm/cm at the surface coated section.

Example 6 includes the subject matter of any of Examples 1-5, further including a solder contact in electrical contact with the exposed surface section.

Example 7 includes the subject matter of Example 6, further including a conductor in electrical contact with the solder contact.

Example 8 includes the subject matter of Examples 7 or 8, wherein the conductor, the solder contact, and the exposed surface section collectively have an electrical resistance less than 300 Ohm/cm.

Example 9 includes the subject matter of any of Examples 1-8, wherein the surface coated section and the exposed surface section are adjacent.

Example 10 includes the subject matter of any of Examples 1-9, wherein one or more of the first portion of the plurality of nanofibers and the second portion of the plurality of nanofibers has a diameter of less than 100 μm.

Example 11 includes the subject matter of any of Examples 1-9, wherein one or more of the first plurality of nanofibers and the second plurality of nanofibers has a diameter of less than 50 μm.

Example 12 includes the subject matter of any of any of the preceding Examples, wherein the nanofibers are carbon nanofibers.

Example 13 includes the subject matter of Example 12, wherein the carbon nanofibers are multiwalled carbon nanofibers.

Example 14 is a nanofiber yarn including a plurality of nanofibers defining an external surface of the nanofiber yarn; and an infiltration material disposed within at least some of a plurality of inter-fiber interstitial spaces in an interior of the nanofiber yarn, wherein the external surface of the nanofiber yarn is substantially free of the infiltration material.

Example 15 includes the subject matter of Example 14, wherein the external surface comprises outer surfaces of carbon nanofibers.

Example 16 includes the subject matter of Examples 14 and 15, further comprising a conductor in electrical contact and direct physical contact with a portion of the external surface.

Example 17 includes the subject matter of any of Examples 14-16, further comprising a solder contact in electrical contact and direct physical contact with a portion of the external surface.

Example 18 includes the subject matter of Example 17, wherein the solder contact, and external surface collectively have an electrical resistance less than 300 Ohm/cm.

Example 19 includes the subject matter of any of Examples 14-18, wherein the infiltration material is a non-conductive polymer.

Example 20 includes the subject matter of any of Examples 14-19, wherein the infiltration material comprises a polymer and a nanoparticle within the polymer.

Example 21 is a method for fabricating a nanofiber structure that includes providing a collection of nanofibers; applying an infiltration material to the collection of nanofibers; forming a coating of the infiltration material on an exterior surface of the collection of nanofibers and infiltrating an interior of the collection of nanofibers with the infiltration material; and removing the coating of the infiltration material on the exterior surface of the nanofiber structure.

Example 22 includes the subject of Example 21, wherein removing the coating of the infiltration material includes applying a vacuum to the collection of nanofibers.

Example 23 includes the subject matter of either of Examples 21 or 22, wherein the removing includes applying a burst of fluid to the coating of the infiltration material.

Example 24 includes the subject matter of any of Examples 21-23, wherein the infiltration material remains within the interior of the collection of nanofibers after removing the coating of the infiltration material on the exterior surface of the collection of nanofibers.

Example 25 includes the subject matter of any of Examples 21-24, further comprising placing a solder contact in direct physical contact with the exterior surface of the collection of nanofibers after removing the coating of the infiltration material.

Example 26 includes the subject matter of any of Examples 21-25, wherein the provided collection of nanofibers is drawn from a forest of nanofibers.

### BRIEF DESCRIPTION OF THE DRAWINGS

FIG. 1 illustrates an example forest of nanofibers on a substrate, in an embodiment.

FIG. 2 illustrates an example reactor used for growing nanofibers, in an embodiment.

FIG. 3 is an illustration of a nanofiber sheet that identifies relative dimensions of the sheet and schematically illustrates nanofibers within the sheet aligned end-to-end in a plane parallel to a surface of the sheet, in an embodiment.

FIG. 4 is an image of a nanofiber sheet being laterally drawn from a nanofiber forest, the nanofibers aligning from end-to-end as schematically.

FIG. 5A is a schematic side view of a nanofiber yarn being infiltrated with a material and from which an external layer of the infiltration material is removed from a portion of the nanofiber yarn, in an embodiment.

FIGS. 5B, 5C, and 5D are cross-sectional views of each of the three sections of the nanofiber yarn shown in FIG. 5A, in an embodiment.

FIG. 6 is a schematic side view of a system for infiltrating a nanofiber yarn with a material and removing an external layer of the infiltration material from an external surface of the nanofiber yarn, in an embodiment.

FIG. 7 is a method flow diagram illustrating an example method for infiltrating a nanofiber yarn with a material and removing an external layer of the infiltrating material from an external surface of the nanofiber yarn, in an embodiment.

FIG. 8 is a graph of electrical resistance versus nanofiber yarn location for a nanofiber yarn prepared according to embodiments of the present disclosure.

The figures depict various embodiments of the present disclosure for purposes of illustration only. Numerous variations, configurations, and other embodiments will be apparent from the following detailed discussion.

### DETAILED DESCRIPTION

### OVERVIEW

Infiltrating a material into the interstitial spaces between nanofibers in a nanofiber yarn can enhance various properties (whether chemical, mechanical, or electrical) of the nanofiber yarn. Generally, a layer of the material infiltrated into the nanofiber yarn also remains disposed on an exterior surface of the nanofiber yarn. For examples in which the infiltrated material is not electrically conductive (e.g., a non-conductive polymer or a material filled with an electrical insulator), the layer on the exterior of the nanofiber yarn makes it challenging to establish electrically conductive contact (e.g., conductivity comparable to or greater than that of electrical solders) with the nanofiber yarn. For examples in which the nanofibers themselves are conductive (e.g., carbon nanofibers), an electrically resistive coating at an exterior of the infiltrated nanofiber yarn can impede the use of the nanofiber yarn in applications that rely on an electrically conductive connection with other elements of a system. In other words, while the nanofiber yarn may be conductive, the exterior layer of non-conductive (or insulative) material places the conductive nanofiber yarn in electrical isolation. Removing portions of the infiltration material from an exterior surface of the nanofiber yarn after infiltration can be challenging. Often the infiltration material disposed on the surface of the nanofiber yarn is securely attached to (and/or integral with) infiltration material within an interior (i.e., within a boundary formed by an exterior surface) of the nanofiber yarn. Removing the external surface layer thermally or chemically can damage other portions of the infiltrated nanofiber yarn, including the nanofibers themselves. This can, in turn, degrade the electrical and/or mechanical properties of the nanofiber yarn.

Thus, in accordance with an embodiment of the present disclosure, techniques are described for infiltrating a nanofiber yarn with an infiltration material and removing a surface layer of the infiltration material on at least a portion of the infiltrated nanofiber yarn. This enables an infiltration method by which the infiltration material is selectively disposed within an interior of a nanofiber yarn and not disposed on an exterior surface of at least a portion of a nanofiber yarn. An advantage of embodiments of nanofiber yarns that have portions of an external surface free (whether completely free or substantially free) from an infiltration material is that these nanofibers (and the yarns or other configurations made therefrom) can be electrically connected to other elements of an electrical system. Electrical connection can be established by connecting, contacting, or mounting an electrode (e.g., a conductive clamp or fitting) directly to the exposed surface of the nanofiber yarn. Electrical connection can also be established by soldering an electrical conductor (e.g., a copper or aluminum wire) to the exposed surface of the nanofiber yarn. Any of these examples increases the number of applications in which infiltrated nanofibers can be used.

### NANOFIBER FORESTS

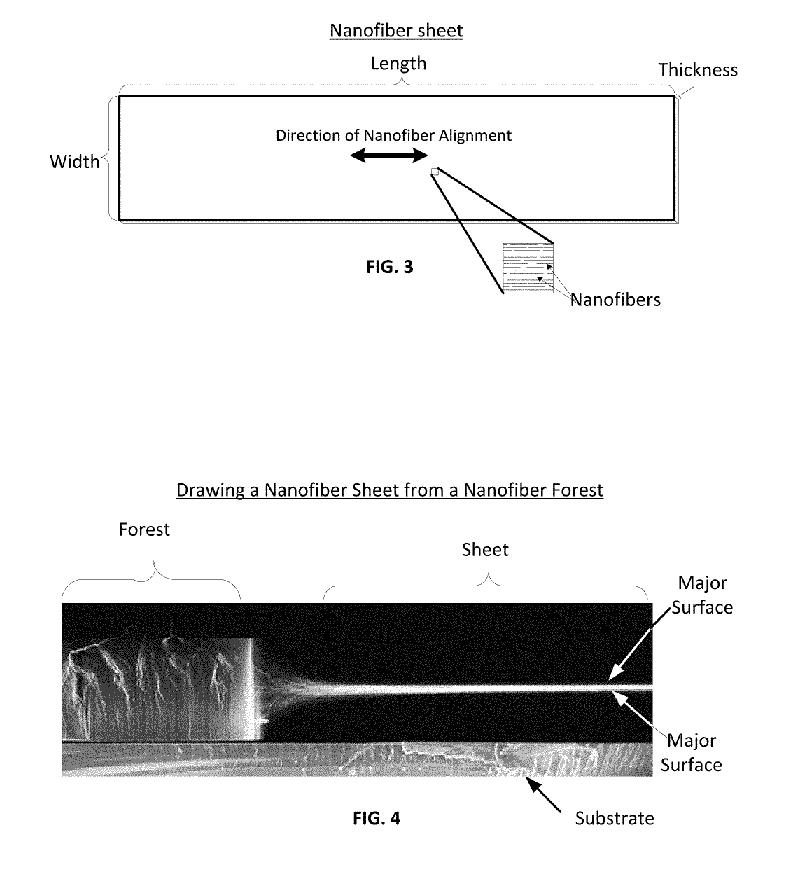

As used herein, the term “nanofiber” means a fiber having a diameter less than 1 μm. While the embodiments herein are primarily described as fabricated from carbon nanotubes, it will be appreciated that other carbon allotropes, whether graphene, micron or nano-scale graphite fibers and/or plates, and even other compositions of nano-scale fibers such as boron nitride may be densified and/or functionalized using the techniques described below. As used herein, the terms “nanofiber” and “carbon nanotube” encompass both single walled carbon nanotubes and/or multi-walled carbon nanotubes in which carbon atoms are linked together to form a cylindrical structure. In some embodiments, carbon nanotubes as referenced herein have between 4 and 10 walls. As used herein, a “nanofiber sheet” or simply “sheet” refers to a sheet of nanofibers aligned via a drawing process (as described in PCT Publication No. WO 2007/015710, and incorporated by reference herein in its entirety) so that a longitudinal axis of a nanofiber of the sheet is parallel to a major surface of the sheet, rather than perpendicular to the major surface of the sheet (i.e., in the as-deposited form of the sheet, often referred to as a “forest”). This is illustrated and shown in FIGS. 3 and 4, respectively.

The dimensions of carbon nanotubes can vary greatly depending on production methods used. For example, the diameter of a carbon nanotube may be from 0.4 nm to 100 nm and its length may range from 10 μm to greater than 55.5 cm. Carbon nanotubes are also capable of having very high aspect ratios (ratio of length to diameter) with some as high as 132,000,000:1 or more. Given the wide range of dimensional possibilities, the properties of carbon nanotubes are highly adjustable, or “tunable.” While many intriguing properties of carbon nanotubes have been identified, harnessing the properties of carbon nanotubes in practical applications requires scalable and controllable production methods that allow the features of the carbon nanotubes to be maintained or enhanced.

Due to their unique structure, carbon nanotubes possess particular mechanical, electrical, chemical, thermal and optical properties that make them well-suited for certain applications. In particular, carbon nanotubes exhibit superior electrical conductivity, high mechanical strength, good thermal stability and are also hydrophobic. In addition to these properties, carbon nanotubes may also exhibit useful optical properties. For example, carbon nanotubes may be used in light-emitting diodes (LEDs) and photo-detectors to emit or detect light at narrowly selected wavelengths. Carbon nanotubes may also prove useful for photon transport and/or phonon transport.

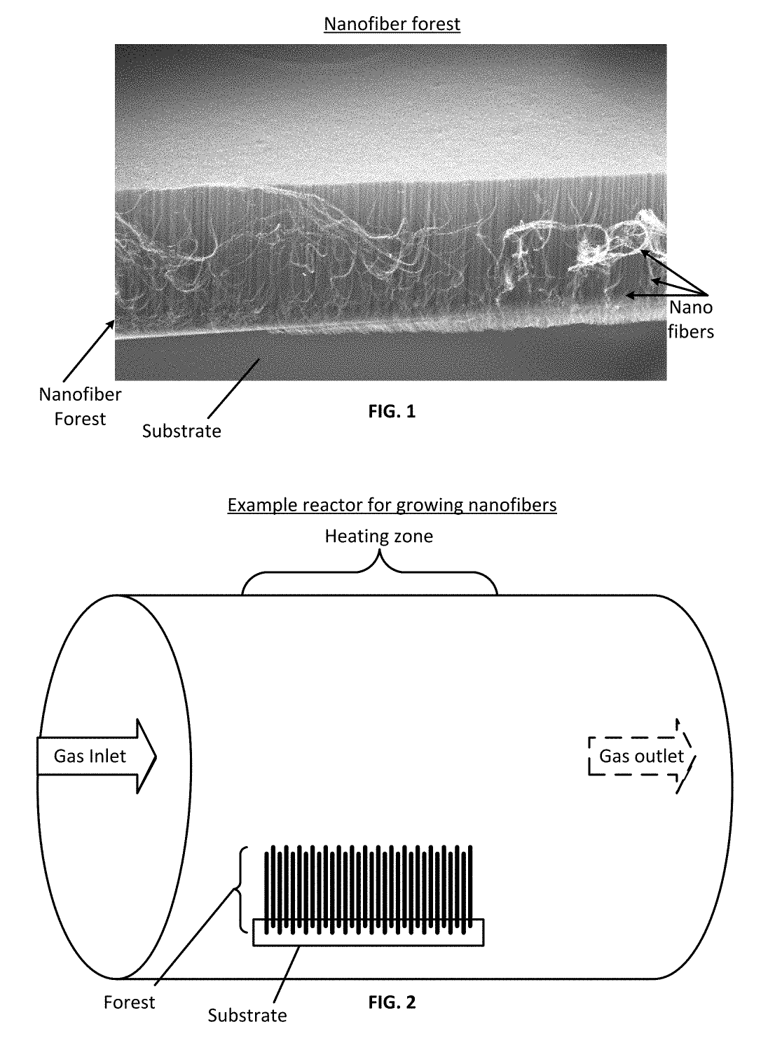

In accordance with various embodiments of the subject disclosure, nanofibers (including but not limited to carbon nanotubes) can be arranged in various configurations, including in a configuration referred to herein as a “forest.” As used herein, a “forest” of nanofibers or carbon nanotubes refers to an array of nanofibers having approximately equivalent dimensions that are arranged substantially parallel to one another on a substrate. FIG. 1 shows an example forest of nanofibers on a substrate. The substrate may be any shape but in some embodiments the substrate has a planar surface on which the forest is assembled. As can be seen in FIG. 1, the nanofibers in the forest may be approximately equal in height and/or diameter.

Nanofiber forests as disclosed herein may be relatively dense. Specifically, the disclosed nanofiber forests may have a density of at least 1 billion nanofibers/cm². In some specific embodiments, a nanofiber forest as described herein may have a density of between 10 billion/cm² and 30 billion/cm². In other examples, the nanofiber forest as described herein may have a density in the range of 90 billion nanofibers/cm². The forest may include areas of high density or low density and specific areas may be void of nanofibers. The nanofibers within a forest may also exhibit inter-fiber connectivity. For example, neighboring nanofibers within a nanofiber forest may be attracted to one another by van der Waals forces. Regardless, a density of nanofibers within a forest can be increased by applying techniques described herein.

Methods of fabricating a nanofiber forest are described in, for example, PCT No. WO2007/015710, which is incorporated herein by reference in its entirety.

Various methods can be used to produce nanofiber precursor forests. For example, in some embodiments nanofibers may be grown in a high-temperature furnace, schematically illustrated in FIG. 2. In some embodiments, catalyst may be deposited on a substrate, placed in a reactor and then may be exposed to a fuel compound that is supplied to the reactor. Substrates can withstand temperatures of greater than 800° C. or even 1000° C. and may be inert materials. The substrate may comprise stainless steel or aluminum disposed on an underlying silicon (Si) wafer, although other ceramic substrates may be used in place of the Si wafer (e.g., alumina, zirconia, SiO₂, glass ceramics). In examples where the nanofibers of the precursor forest are carbon nanotubes, carbon-based compounds, such as acetylene may be used as fuel compounds. After being introduced to the reactor, the fuel compound(s) may then begin to accumulate on the catalyst and may assemble by growing upward from the substrate to form a forest of nanofibers. The reactor also may include a gas inlet where fuel compound(s) and carrier gasses may be supplied to the reactor and a gas outlet where expended fuel compounds and carrier gases may be released from the reactor. Examples of carrier gases include hydrogen, argon, and helium. These gases, in particular hydrogen, may also be introduced to the reactor to facilitate growth of the nanofiber forest. Additionally, dopants to be incorporated in the nanofibers may be added to the gas stream.

The reaction conditions during nanofiber growth can be altered to adjust the properties of the resulting nanofiber precursor forest. For example, particle size of the catalyst, reaction temperature, gas flow rate and/or the reaction time can be adjusted as needed to produce a nanofiber forest having the desired specifications. In some embodiments, the position of catalyst on the substrate is controlled to form a nanofiber forest having desired patterning. For example, in some embodiments catalyst is deposited on the substrate in a pattern and the resulting forest grown from the patterned catalyst is similarly patterned. Example catalysts include iron with a, buffer layer of silicon oxide (SiO₂) or aluminum oxide (Al₂O₃). These may be deposited on the substrate using chemical vapor deposition (CVD), pressure assisted chemical vapor deposition (PCVD), electron beam (eBeam) deposition, sputtering, atomic layer deposition (ALD), plasma enhanced chemical vapor deposition (PECVD), among others.

In some particular embodiments, multiple nanofiber precursor forests may be sequentially grown on the same substrate to form a multilayered nanofiber forest, alternatively referred to as a “stack.”

In a process used to fabricate a multilayered nanofiber forest, one nanofiber forest is formed on a substrate followed by the growth of a second nanofiber forest in contact with the first nanofiber forest. Multi-layered nanofiber forests can be formed by numerous suitable methods, such as by forming a first nanofiber forest on the substrate, depositing catalyst on the first nanofiber forest and then introducing additional fuel compound to the reactor to encourage growth of a second nanofiber forest from the catalyst positioned on the first nanofiber forest. Depending on the growth methodology applied, the type of catalyst, and the location of the catalyst, the second nanofiber layer may either grow on top of the first nanofiber layer or, after refreshing the catalyst, for example with hydrogen gas, grow directly on the substrate thus growing under the first nanofiber layer. Regardless, the second nanofiber forest can be aligned approximately end-to-end with the nanofibers of the first nanofiber forest although there is a readily detectable interface between the first and second forest. Multi-layered nanofiber forests may include any number of forests. For example, a multi-layered precursor forest may include two, three, four, five or more forests.

### NANOFIBER SHEETS

In addition to arrangement in a forest configuration, the nanofibers of the subject application may also be arranged in a sheet configuration. As used herein, the term “nanofiber sheet,” “nanotube sheet,” or simply “sheet” refers to an arrangement of nanofibers where the nanofibers are aligned end to end in a plane. An illustration of an example nanofiber sheet is shown in FIG. 3 with labels of the dimensions. In some embodiments, the sheet has a length and/or width that is more than 100 times greater than the thickness of the sheet. In some embodiments, the length, width or both, are more than 10³, 10⁶ or 10⁹ times greater than the average thickness of the sheet. A nanofiber sheet can have a thickness of, for example, between approximately 5 nm and 30 μm and any length and width that are suitable for the intended application. In some embodiments, a nanofiber sheet may have a length of between 1 cm and 10 meters and a width between 1 cm and 1 meter. These lengths are provided merely for illustration. The length and width of a nanofiber sheet are constrained by the configuration of the manufacturing equipment and not by the physical or chemical properties of any of the nanotubes, forest, or nanofiber sheet. For example, continuous processes can produce sheets of any length. These sheets can be wound onto a roll as they are produced.

As can be seen in FIG. 3, the axis in which the nanofibers are aligned end-to end is referred to as the direction of nanofiber alignment. In some embodiments, the direction of nanofiber alignment may be continuous throughout an entire nanofiber sheet. Nanofibers are not necessarily perfectly parallel to each other and it is understood that the direction of nanofiber alignment is an average or general measure of the direction of alignment of the nanofibers.

Nanofiber sheets may be assembled using any type of suitable process capable of producing the sheet. In some example embodiments, nanofiber sheets may be drawn from a nanofiber forest. An example of a nanofiber sheet being drawn from a nanofiber forest is shown in FIG. 4

As can be seen in FIG. 4, the nanofibers may be drawn laterally from the forest and then align end-to-end to form a nanofiber sheet. In embodiments where a nanofiber sheet is drawn from a nanofiber forest, the dimensions of the forest may be controlled to form a nanofiber sheet having particular dimensions. For example, the width of the nanofiber sheet may be approximately equal to the width of the nanofiber forest from which the sheet was drawn. Additionally, the length of the sheet can be controlled, for example, by concluding the draw process when the desired sheet length has been achieved.

Nanofiber sheets have many properties that can be exploited for various applications. For example, nanofiber sheets may have tunable opacity, high mechanical strength and flexibility, thermal and electrical conductivity, and may also exhibit hydrophobicity. Given the high degree of alignment of the nanofibers within a sheet, a nanofiber sheet may be extremely thin. In some examples, a nanofiber sheet is on the order of approximately 10 nm thick (as measured within normal measurement tolerances), rendering it nearly two-dimensional. In other examples, the thickness of a nanofiber sheet can be as high as 200 nm or 300 nm. As such, nanofiber sheets may add minimal additional thickness to a component.

As with nanofiber forests, the nanofibers in a nanofibers sheet may be functionalized by a treatment agent by adding chemical groups or elements to a surface of the nanofibers of the sheet and that provide a different chemical activity than the nanofibers alone. Functionalization of a nanofiber sheet can be performed on previously functionalized nanofibers or can be performed on previously unfunctionalized nanofibers. Functionalization can be performed using any of the techniques described herein including, but not limited to CVD, and various doping techniques.

Nanofiber sheets, as drawn from a nanofiber forest, may also have high purity, wherein more than 90%, more than 95% or more than 99% of the weight percent of the nanofiber sheet is attributable to nanofibers, in some instances. Similarly, the nanofiber sheet may comprise more than 90%, more than 95%, more than 99% or more than 99.9% by weight of carbon.

### SELECTIVE INFILTRATION OF AN INFILTRATION MATERIAL IN A NANOFIBER YARN

While the following examples are primarily focused on yarns (whether a single ply yarn or a multi-ply yarn of two or more individual yarns plied together), this is merely for convenience of explanation. It will be appreciated that other forms of nanofibers, not only yarns, can be used as a substitute for the nanofiber yarn described in the following examples. For example, strands of nanofibers drawn from a forest but not twisted (or false-twisted) into yarn may also be treated according to embodiments of the present disclosure. Embodiments of nanofibers, whether yarns, untwisted strands, densified, not densified, or forests, will be referred to generically as “collections” or “structures “of nanofibers.

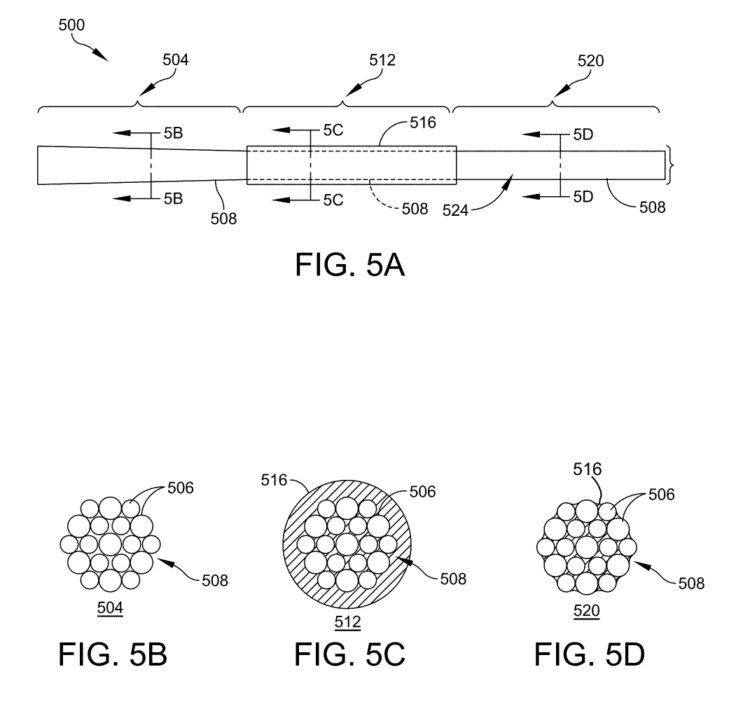

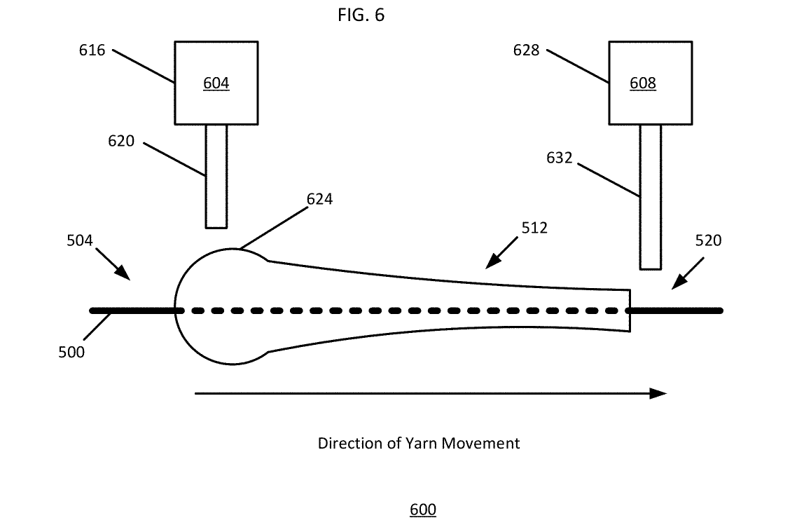

FIG. 5A is a schematic side view of an example nanofiber yarn 500 at various stages of processing. Specifically, the example nanofiber yarn 500 illustrated is shown as having three sections, 504, 512, and 520, each of which corresponds to a different stage of processing. Infiltration material is selectively disposed in some portions of the sections 512, 520, as is explained below in more detail. It will be appreciated that in this example, all three of the sections are continuous and/or connected to one another (e.g., the nanofibers forming the yarns in each of the sections lack joining seams or joints).

The first section 504 of the nanofiber yarn 500 is an untreated, or “native,” portion of the nanofiber yarn 500. In one example, this first section 504 corresponds to the nanofiber yarn 500 prior to infiltration.

This first section 504 includes an exterior surface 508 formed by a portion of the individual nanofibers that is exposed to the atmosphere in the processing environment. The first section 504 as shown has yet to be infiltrated by another material, whether a solution, a polymer, polymer solution, or polymer and filler particles, in examples. The exterior surface 508 thus is not coated with or concealed by the infiltration material. Furthermore, as is illustrated in FIG. 5A, a diameter of the first section 504 is greater than a diameter of the second section 512 and third section 520 due to the “densifying” effect that an infiltration material can have on a collection of nanofibers (such as a nanofiber yarn), as described in PCT Publication No. WO 2007/015710.

The second section 512 of the nanofiber yarn 500 has an infiltration material 516 disposed on the exterior surface 508 of the nanofiber yarn 500 and also disposed within an interior of the nanofiber yarn (i.e., within the inter-fiber interstitial spaces between the nanofibers 506 as shown in FIGS. 5C). As shown, with reference to both FIGS. 5A and 5C, the infiltration material 516 coats the exterior surface 508 of the second section 512, thus concealing it from the atmosphere in the processing environment. It will be appreciated that the thickness of the coating of infiltration material is exaggerated for convenience of explanation. In examples, the actual thickness of the coating of infiltration material 516 is less than 5 microns or even less than 1 micron.

The third section 520 of the nanofiber yarn 500 includes the nanofiber yarn that has been infiltrated by the infiltration material. The infiltration material 516 is thus disposed within an interior 524 of the nanofiber yarn 500. More specifically, the infiltration material 516 is disposed within interstitial spaces defined by the nanofibers 506 within the third section 520 of the nanofiber yarn 500. This is illustrated in the cross-section of FIG. 5D. As will be described below in more detail, the exterior surface 508 of the third section 520 of the nanofiber yarn 500 is once again exposed to the atmosphere in the processing environment and substantially free of the infiltration material, thus able to have an electrical connection with a conductor (e.g., a copper wire) with an interfacial contact resistance that is less than 3000 Ohm/cm. In some examples, “substantially free” means that at least 50% exterior surface 508 is free of infiltration material (whether a continuous area or in discrete areas that are separated but total 50%), thus exposing at least portions of the nanofibers to the ambient environment. In other examples, “substantially free” can mean that infiltration material covers the surface of the nanofiber yarn in a layer that averages less than 1 micron thick and thus does not provide a significant electrical or mechanical barrier to an applied physical force (e.g., heating by a solder gun, impingement by an conductive clamp) or an electrical force (e.g., an applied voltage). Regardless, the substantial absence of infiltration material 516 on the external surface is because the coating of the infiltration material has been removed by, for example, a vacuum. Removal of the surface coating of infiltration material is controlled so that the infiltration material 516 within the interior 524 of the third section 520 of the nanofiber yarn 500 remains.

FIGS. 5B, 5C, and 5D illustrate a cross-section for each one of the three sections shown in FIG. 5A. As shown in FIG. 5B, the cross-section of the first section 504 includes a plurality of nanofibers 506 (defining a plurality of interstitial spaces between the nanofibers on an interior of the collection of nanofibers) and also includes the exposed exterior surface 508. As shown in FIG. 5C, the cross-section of the second section 512 shows this portion of the nanofiber yarn 500 as both infiltrated by, and coated with, the infiltration material 516. Thus, the exterior surface 508 exposed to the atmosphere at the first section 504 is now coated with the infiltration material 516. The cross-section of the third section 520, depicted in FIG. 5D, shows the infiltration material 516 disposed within an interior 524 of the third section 520 of the nanofiber yarn 500 (i.e., within interstitial spaces defined by the individual nanofibers 506). Unlike the second section 512, the third section 520 has an exterior surface 508 that is once again exposed to the atmosphere in the processing environment due to removal of the portion of the infiltration material 516 disposed on, and coating, the exterior surface 508.

### EXAMPLE SYSTEM AND METHOD

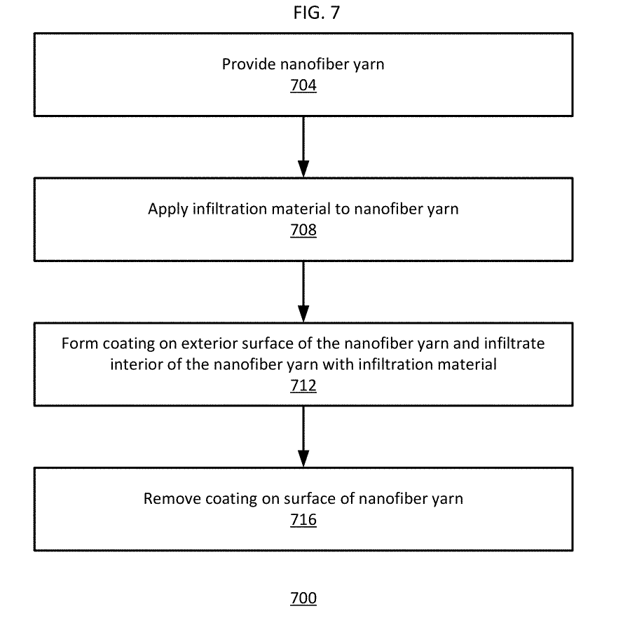

FIG. 6 illustrates an example system 600 for controlling infiltration of a nanofiber yarn with an infiltration material. FIG. 7 illustrates a method flow diagram of an example method 700 for controlling infiltration of the nanofiber yarn, in an embodiment. Concurrent reference to FIG. 6 and FIG. 7 will facilitate explanation.

The system 600 includes an infiltration material applicator 604 and an infiltration material remover 608. Other elements that can be used for the spinning of nanofibers into a nanofiber yarn, optionally densifying a nanofiber yarn, guiding the nanofiber yarn throughout the system 600, and winding the processed nanofiber yarn, such as those described in PCT Publication No. WO 2007/015710 are omitted for clarity of explanation.

As shown, a nanofiber yarn 500 is provided 704 to the system 600. When processed using the system 600, the nanofiber yarn 500 will have a first section 504, a second section 512, and a third section 520, as depicted above in FIGS. 5A-5D. In an example, the nanofiber yarn 500 is drawn from a nanofiber forest and spun into a nanofiber yarn as described above and in PCT Publication WO 2007/015710, incorporated by reference herein in its entirety. However, it will be appreciated that other types of nanofiber yarns can be provided 704 to the system 600.

After being provided 704, the nanofiber yarn 500 is then passed proximate to the infiltration material applicator 604. The infiltration material application 604 applies 708 an infiltration material to the nanofiber yarn 500, thus creating the second section 512 depicted in FIG. 5C. The infiltration material applicator 604 includes a reservoir 616 and a channel 620. The reservoir 616 stores the liquid or molten infiltration material and the channel 620 allows the stored infiltration material to flow from the reservoir 616 onto the nanofiber yarn 500 as the nanofiber yarn is drawn past a dispense opening defined by an end of the channel 620 that is opposite the reservoir 616. In some examples, the infiltration material applicator 604 includes a controller (not shown) that controls a rate at which the infiltration material is applied 708 to the nanofiber yarn and/or an amount of the infiltration material applied 708. Specific examples of controllers include mass flow controllers, peristaltic pumps, timing valves, among others. The rate and/or amount applied 708 can be selected in coordination with a speed at which the nanofiber yarn passes by the dispense opening of the channel. In other examples, the channel 620 includes a valve that opens and closes so as to control the amount, periodicity, and/or rate of infiltration material dispensation.

Once dispensed, the infiltration material forms 712 a coating 624 on an exterior of the second section 512 of the nanofiber yarn 500. The infiltration material also infiltrates an interior of the nanofiber yarn, as described and illustrated above. Example of infiltration materials include molten polymers such as thermoplastics (e.g. polyethylene, polypropylene), epoxides in a pre-cured, viscoelastic state, polymer/solvent solutions (e.g., polyethylene in toluene), and polymers or polymer/solvent solutions that include colloidal particles or nanoparticles in suspension (e.g., polyethylene in toluene with silver nanoparticles). In some examples, the infiltration material not only infiltrates interstitial spaces between individual nanofibers (i.e., interstitial spaces) disposed within an interior of the nanofiber yarn and coats an exterior surface, but also can cause the individual nanofiber to draw closer together. This “densification,” referred to above, can improve various properties of the nanofiber yarn, include increasing tensile strength and electrical conductivity, among other properties. In some cases, infiltration can increase density (mass/unit volume) of a nanofiber yarn by a factor of greater than 1.5, greater than 2.0 or greater than 3.0.

A portion of the coating 624 on the surface of the nanofiber yarn 500 is then removed 716, as a fluid material, by the infiltration material remover 608. In the example described below, this removal 716 is contactless by application of a vacuum applied by infiltration material remover 608 to the surface coating 624. In the example system 600, the remover 608 includes a vacuum source 628 and a conduit 632 that is used to apply the vacuum to the location proximate to the surface coating 624. It will be appreciated that other types of remover 608 using different removal mechanisms can be used to remove the surface coating 624. For example, an impingement mechanism can be used to scrape off the surface coating 624 (e.g., a squeegee or a toroidal shaped scraper). In another example, focused bursts of fluid (e.g., compressed air, solvent) can be used to remove the surface coating 624. In some embodiments, the conduit 632 comprises an annular ring that surrounds the nanofiber yarn 500 and provides the vacuum, solvent, impingement, or other material removal mechanism to an entire circumference of the yarn. Other types of removal methods will be appreciated in light of this disclosure.

Regardless of the method used to remove 716 the surface coating 624, this removal 716 results in a structure of nanofiber yarn described above as the third section 520 and depicted in FIG. 5D. The interior interstices are infiltrated with the infiltration material while the external surface of the yarn is free or substantially free of infiltration material.

Returning to the example system 600, the applied vacuum removes 716 the portion of the coating of infiltration material on the exterior surface of the nanofiber yarn. A sufficient vacuum pressure is applied to the surface coating 624 to remove the surface coating 624 but leave at least a portion of the infiltration material disposed within the interstitial spaces between nanofiber in an interior of the nanofiber yarn 612. The vacuum pressure to accomplish this is determined in part by the volume of vacuum produced by the vacuum source 628, an opening defined by the conduit 632 that is proximate to the nanofiber yarn 612, and a distance separating the nanofiber yarn 612 and the opening defined by the conduit 632. Furthermore, the vacuum pressure can be varied depending on the viscosity of the infiltration material. More vacuum pressure can be applied if the viscosity of the infiltration material is higher. Examples of situations in which a higher vacuum pressure is applied include a molten polymer approaching its glass transition temperature, a polymer/solvent solution in which the solvent content is sufficient to swell but not solvate the polymer, and an epoxy in which the epoxide reaction has progressed relative to formation 712 of the coating 624.

### EXPERIMENTAL EXAMPLE

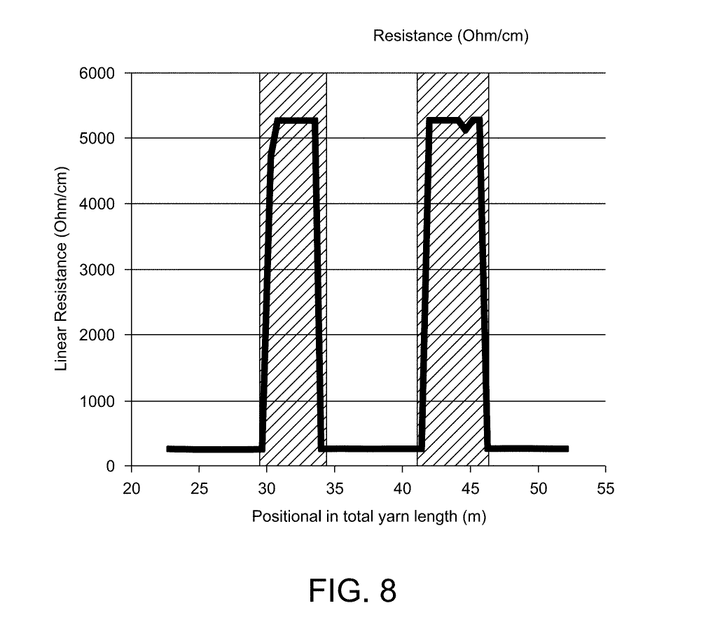

FIG. 8 illustrates results of an experimental example in which embodiments described here were applied to a nanofiber yarn. In this example 0.3 weight % polyvinyl alcohol (PVA) in dimethyl sulfoxide (DMSO) solution was prepared. This polymer solution was applied to a carbon nanotube (CNT) yarn as the yarn was being fabricated. The CNT forest, sheet, and yarn were prepared according to methods described above and in PCT Publication No. WO 2007/015710. The CNT yarn produced from the CNT sheet drawn from the CNT forest was false twisted using, for example, methods described in U.S. patent application Ser. No. 62/435,878, which is incorporated herein in its entirety. In this experimental example, the yarn diameter was approximately 28 microns (+/−10% due to measurement error and normal variation in diameter).

The provided yarn was then coated and infiltrated with the PVA solution described above. Vacuum was alternately applied and then not applied so that external surface regions of the yarn alternately not coated and coated with the PVA solution corresponding to whether the vacuum was applied or not applied, respectively. The remaining material was cured by allowing the DMSO to evaporate.

Two electrodes were then placed into electrical contact with sections that did not include a coating of PVA on an external surface and the linear resistance of the CNT yarn was measured. Similarly, the two electrodes were placed into electrical contact with sections that did include the coating of PVA on the external surface. The linear resistance of the CNT yarn was measured for these sections also.

The results of these linear resistance measurement is shown in FIG. 8. Shaded regions indicate electrical resistance of regions of the CNT yarn that did include a coating of PVA on the corresponding section of nanofiber yarn. As shown, for sections of the nanofiber yarn lacking PVA on an external surface (i.e., section to which the external PVA layer was removed by vacuum), the measured resistance with 250 Ω/cm. For sections that included PVA on the external surface (i.e., where no vacuum was applied), the resistance was 5250 Ω/cm.

### FURTHER CONSIDERATIONS

The foregoing description of the embodiments of the disclosure has been presented for the purpose of illustration; it is not intended to be exhaustive or to limit the claims to the precise forms disclosed. Persons skilled in the relevant art can appreciate that many modifications and variations are possible in light of the above disclosure.

The language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments is intended to be illustrative, but not limiting, of the scope of the invention, which is set forth in the following claims.

What is claimed is:

1. A collection of continuous nanofibers comprising:
a surface coated section comprising:
a first portion of a plurality of nanofibers defining a first plurality of inter-fiber interstitial spaces in a first interior and having a first external surface;
an infiltration material disposed within at least some of the first plurality of inter-fiber interstitial spaces and disposed on the first external surface of the surface coated section;
an exposed surface section continuous with the surface coated section, the exposed surface section comprising:
a second portion of the plurality of nanofibers defining a second plurality of inter-fiber interstitial spaces in a second interior and defining a second external surface; and
the infiltration material disposed within at least some of the second plurality of inter-fiber interstitial spaces, wherein the second external surface is substantially free of the infiltration material.

2. The collection of continuous nanofibers of claim 1, further comprising a native section comprising a third portion of the plurality of nanofibers defining a third plurality of inter-fiber interstitial spaces in a third interior and defining a third external surface, wherein the third plurality of inter-fiber interstitial spaces and the third external surface are free of the infiltration material.

3. The collection of continuous nanofibers of claim 1, further comprising a conductor in electrical contact with the second external surface substantially free of the infiltration material.

4. The collection of continuous nanofibers of claim 3, wherein an electrical resistance between the conductor and the collection of continuous nanofibers is less than 3000 Ohm/cm.

5. The collection of continuous nanofibers of claim 1, further comprising an electrical resistance of less than 3000 Ohm/cm at the second external surface that is substantially free of the infiltration material and an electrical resistance of greater than 3000 Ohm/cm at the first external surface of the surface coated section.

6. The collection of continuous nanofibers of claim 1, further comprising a solder contact in electrical contact with the exposed surface section.

7. The collection of continuous nanofibers of claim 6, further comprising a conductor in electrical contact with the solder contact.

8. The collection of continuous nanofibers of claim 7, wherein the conductor, the solder contact, and the exposed surface section collectively have an electrical resistance less than 300 Ohm/cm.

9. The collection of continuous nanofibers of claim 1, wherein the surface coated section and the exposed surface section are adjacent.

10. The collection of continuous nanofibers of claim 1, wherein one or more of the first portion of the plurality of nanofibers and the second portion of the plurality of nanofibers has a diameter of less than 100 μm.

11. The collection of continuous nanofibers of claim 1, wherein one or more of the first portion of the plurality of nanofibers and the second portion of the plurality of nanofibers has a diameter of less than 50 μm.

12. The collection of continuous nanofibers of claim 1, wherein the nanofibers are carbon nanofibers.

13. The collection of continuous nanofibers of claim 12, wherein the carbon nanofibers are multiwalled carbon nanofibers.

14. A nanofiber yarn comprising:
a plurality of nanofibers defining an external surface of the nanofiber yarn; and
an infiltration material disposed within at least some of a plurality of inter-fiber interstitial spaces in an interior of the nanofiber yarn,
wherein the external surface of the nanofiber yarn is substantially free of the infiltration material.

15. The nanofiber yarn of claim 14, wherein the external surface comprises outer surfaces of carbon nanofibers.

16. The nanofiber yarn of claim 14, further comprising a conductor in electrical contact and direct physical contact with a portion of the external surface.

17. The nanofiber yarn of claim 14, further comprising a solder contact in electrical contact and direct physical contact with a portion of the external surface.

18. The nanofiber yarn of claim 17, wherein the solder contact, and external surface collectively have an electrical resistance less than 300 Ohm/cm.

19. The nanofiber yarn of claim 14, wherein the infiltration material is a non-conductive polymer.

20. The nanofiber yarn of claim 14, wherein the infiltration material comprises a polymer and nanoparticles within the polymer.

21. A method for fabricating a nanofiber structure comprising:
providing a collection of nanofibers;
applying an infiltration material to the collection of nanofibers;
forming a coating of the infiltration material on an exterior surface of the collection of nanofibers and infiltrating an interior of the collection of nanofibers with the infiltration material; and
removing the coating of the infiltration material on the exterior surface of the nanofiber structure.

22. The method of claim 21, wherein the removing the coating of the infiltration material includes applying a vacuum to the collection of nanofibers.

23. The method of claim 21, wherein the removing includes applying a burst of fluid to the coating of the infiltration material.

24. The method of claim 21, wherein the infiltration material remains within the interior of the collection of nanofibers after removing the coating of the infiltration material on the exterior surface of the collection of nanofibers.

25. The method of claim 21, further comprising placing a solder contact in direct physical contact with the exterior surface of the collection of nanofibers after removing the coating of the infiltration material.

26. The method of claim 21, wherein the provided collection of nanofibers is drawn from a forest of nanofibers.
